(19) United States
(12) Patent Application Publication
(10) Pub. No.: US 2023/0204218 A1
(43) Pub. Date: Jun. 29, 2023

(54) Portable BBQ grill

(71) Applicant: Tibogrill Inc, Ottawa, Ontario (CA)

(72) Inventors: Gerard Thibault, Kanata, Ontario (CA); David Andrew McMullin, Ottawa, Ontario (CA); William Dicke, Gatineau, Quebec (CA)

(21) Appl. No.: 17/998,044

(22) PCT Filed: May 18, 2021
(86) PCT No.: PCT/CA2021/000044

§ 371 Date: Nov. 7, 2022

Related U.S. Application Data
(60) Provisional application No. 63/026,838, filed on May 19, 2020.

(51) Int. Cl. F24C 3/14; A47J 37/07; A47J 37/04; A47J 37/10

(52) U.S. Cl. CPC F24C 3/14; A47J 37/0763; A47J 37/0713; A47J 37/0786; A47J 37/041; A47J 37/10

(57) ABSTRACT

Disclosed is a BBQ Grill comprising two lower side panels, two upper side panels that are slideably received in the lower side panels. Crossbraces space the panels apart and a grill plate is adapted to detachably engage hooks on the upper side panels. The grill has legs that extend and retract associated with the lower side panels and the upper side panels have a handle assembly with a button to set pawls of a latch plate at selected apertures associated with the lower side panel. Various accessories are disclosed. The grill can be used with wood, charcoal briquettes or a gas burner.

### FIELD OF THE INVENTION

The invention relates to a portable grill for barbequing and more particularly, a grill that may be assembled and disassembled easily to provide a compact grill for transportation. The grill may include a spring activated rotating spit.

### BACKGROUND OF THE INVENTION

Portable BBQs and rotisseries are well known. U.S. Pat. No. 3,059,568 to Fortis, Oct. 23, 1962 is foldable into a compact article when not in use. The article is designed for use without requiring an external source of electrical power and designed for use with battery power or a spring-driven motor.

U.S. Pat. No. 3,611,912 to Choc, Oct. 12, 1971 relates to a portable grill with a hinged carrying case openable to form an elongated planar grill base or counter top. Legs are swingable out of the case to support the base at an elevated horizontal position. Sidewall forming members fitting in the case are attachable to the top of the base to form support for hot coal holding racks and permitting grilling or rotisserie operation.

U.S. Pat. No. 5,367,950 to Sarich, Nov. 29, 1994, also relates to a portable vertical heat source rotisserie and includes a pair of removable spit carriers and a pair of removable covers which are configured to provide the function of covering and enclosing the unit and of opening up to serve as drip pans and ash catches.

More recently there is U.S. Pat. No. 6,546,845 to Lanzilli, Apr. 15, 2003, related to a collapsible rotisserie and grill and oven combination. There are folding side panels and a folding rear panel with a front panel for engagement with the side panels.

### SUMMARY OF THE INVENTION

Notwithstanding the numerous portable grills, a further collapsible grill that is sturdy and compact when packaged is desired.

The invention pertains to a portable grill comprising: two lower side panels; two cross braces configured to connect with sides of the lower side panels and to space them apart. A slideable upper side panel is each configured to slideably connect with each one of the lower side panels. A grill plate is configured to connect with the slideable upper side panels.

The lower side panels have inwardly directed C shaped elements at each lateral side, which C shaped elements are adapted to selectively guide the slideable upper side panels upwardly and downardly.

Further, the lower side panels have a vertical array of apertures and the upper side panels have handles and a button operated latch plate, the latch plate having pawls adapted to engage one of the apertures to set a desired vertical height of the upper side panels and a grill plate relative to the lower side panels.

Each of the slideable upper side panels have laterally spaced upwardly directed C shaped hook elements adapted to hold an end portion of the grill plate.

Preferably, the lower side panels have legs adjacent opposed lower sides of lower side panels, the legs being slideable from an inner retracted position to a laterally outer extended position.

Further, the legs are slideable in association with the lower side panels in cooperation with sockets on the lower part of the lower side panels. A centrally located elongate aperture is between the sockets.

There is also a basket assembly selectively attachable to the grill plate with a skewer to hold food pieces or the like.

Applicant's grill is particularly useful with prepacked charcoal or briquettes that can also be carried with the collapsible and packaged grill parts. However, other fire means can be used such as wood. A gas burner assembly is also provided and is adaptable for use with the grill.

Additionally, accessories such as a grill plate shield and light can be attached to at least one of the lower side panels.

### BRIEF DESCRIPTION OF THE DRAWINGS

FIG. 1 is a perspective view of the portable BBQ grill assembly.

FIG. 2 is a perspective view of the portable BBQ grill assembly of FIG. 1, with the grill in a raised position.

FIG. 3 is a top view of the portable BBQ grill assembly of FIG. 1.

FIG. 4 is a perspective view of the outward facing side of the upper side panel.

FIG. 5 is a perspective view of the outward facing side of the outer side panel.

FIG. 6 is a top view of the upper side panel of FIG. 4, nested within the outer side panel of FIG. 5.

FIGS. 7a and 7b are perspective views of the inward facing side and outward facing side of the left foot that attaches on the left side of the outer side panel of FIG. 5.

FIGS. 7c and 7d are perspective views of the outward facing side and inward facing side of the right foot, which are mirror images of the left foot of FIG. 7a and FIG. 7b, that attaches on the right side of the outer side panel of FIG. 5.

FIG. 8a and FIG. 8b are perspective views of a flat spring clip that is associated with each foot and that attaches to the inside surface of the outer side panel of FIG. 5.

FIGS. 9a, 9b and 9c illustrate the assembly of the right foot of FIG. 7b to the outer side panel of FIG. 5.

FIGS. 9d and 9e illustrate the fastening of the right foot of FIG. 7b to the lower side panel of FIG. 5.

FIG. 9f is a cross sectional view of a portion of the right side of the lower panel, taken along line 9f of FIG. 9e and looking upwards, with the flat spring clip of FIG. 8 installed on the outer side panel and to be engaged with the right foot.

FIG. 10a is a perspective view of the outward facing side of the handle which is also shown in FIG. 2 as part of the BBQ grill sidewall assembly.

FIG. 10b is a perspective view of the inward facing side of the handle of FIG. 10a.

FIG. 11 is an exploded perspective view of the assembly of a latch plate and a handle button.

FIG. 12a is an exploded perspective view of the assembly of the latch plate and handle button assembly of FIG. 11 with the handle of FIGS. 10a and 10b.

FIG. 12b is a perspective view of the latch plate and handle assembly of FIG. 12a.

FIG. 12c is an exploded perspective view of the assembly of the latch plate and handle assembly of FIG. 12b with the upper inside panel of FIG. 4.

FIGS. 13a and 13b illustrate the inward facing side and the outward facing side, respectively, of the assembled upper panel with handle of FIG. 12c.

FIGS. 14a and 14b are perspective views of the outward facing side and the inward facing side, respectively, of the cross brace which is shown as part of the portable BBQ grill assembly of FIG. 1.

FIGS. 15a and 15b, respectively, are perspective views of outward facing side and the inward facing side of the rear wall which is shown as part of the portable BBQ grill assembly of FIG. 1, with FIG. 15c a left side view of FIG. 15b.

FIG. 16a and FIG. 16b are perspective views of the back and front of a rear wall. FIGS. 16c and 16d are perspective views illustrating the assembly of the rear wall of FIGS. 16a and 16b to a cross brace of FIG. 14a.

FIGS. 16e and 16f are a sectional view and a partial end view of FIG. 16d, and FIG. 16g is a sectional view of FIG. 16f.

FIGS. 17a and 17b, respectively, are top perspective and bottom perspective views of a grilling plate, with FIG. 17c illustrating its assembly in relation to the portable BBQ grill of assembly and FIG. 17d is a rear perspective view of the assembled portable BBQ grill assembly as previously shown in FIG. 2, also in the raised position.

FIGS. 18a and 18b are perspective views of an alternate grill plate of welded metal rods and its assembly with the grill assembly.

FIGS. 19a and 19b are perspective views of a further alternate grill plate of cast metal and its assembly with a grill assembly, and FIG. 19c illustrates the assembly of a skewer to the grill plate of FIGS. 19a and 19b.

FIGS. 20a and 20b, respectively, are perspective views of the outward facing side and the inward facing side of a skewer handle.

FIGS. 21a and 21b are perspective views of a skewer.

FIG. 22a is a perspective view of an end of the skewer of FIGS. 21a and 21b being detachably assembled with the skewer handle of FIGS. 21a and 21b, with FIG. 22b illustrating an end view of the skewer and a sectional view of the handle assembled together.

FIGS. 23a and 23b are upper and lower perspective views of a skewer tine assembly.

FIGS. 24a, 24b and 24c are perspective views of various parts of the grill basket assembly including, respectively, the basket screen, one (of two) lateral basket sidewall and one (of two) transverse basket sidewalls.

FIG. 25a illustrates a top view of an assembled grill basket, in a collapsed configuration with FIGS. 25b and 25c being perspective views of the grill basket of FIG. 25c being opened, with FIG. 25d illustrating the assembled and opened grill basket of FIG. 25c with the skewer assembly of FIG. 22b installed.

FIG. 26a is a perspective view of the portable BBQ grill assembly with the grilling plate removed, having installed the skewer assembly of FIG. 22b assembled with the skewer tine assembly of FIGS. 23a and 23b.

FIGS. 26b and 26c are perspective views of the portable BBQ grill of FIG. 26a with a small chicken clamped on the skewer, the assembly being rotated 90° from FIG. 26b to FIG. 26c.

FIG. 27a illustrates the assembly of the grilling surface of FIGS. 17a and 17b to the grill basket of FIG. 25b.

FIG. 27b illustrates the insertion of the skewer assembly of FIG. 22b into the grill plate and basket assembly of FIG. 27a, being assembled as a basket unit.

FIG. 27c illustrates the assembled basket unit, including grilling plate, grill basket and skewer assembly, on the portable BBQ grill.

FIGS. 28a to 28h illustrate a burner assembly kit for use with the BBQ grill.

FIGS. 29a and 29b illustrate a frying pan.

FIGS. 30a to 30f illustrate various perspective views and partial perspective views of a rod connectable to the grill and the frying pan to provide a shield to the grilling plate.

FIGS. 31a to 31d illustrate various views or partial views of a telescopic light that is connectable to the grill.

FIGS. 32a and 32b illustrate a cutting board that may be used as part of the BBQ kit.

FIGS. 33a and 33b illustrate a basic carry kit with FIG. 33b open, showing parts of the grill.

### DESCRIPTION OF PREFERRED EMBODIMENTS

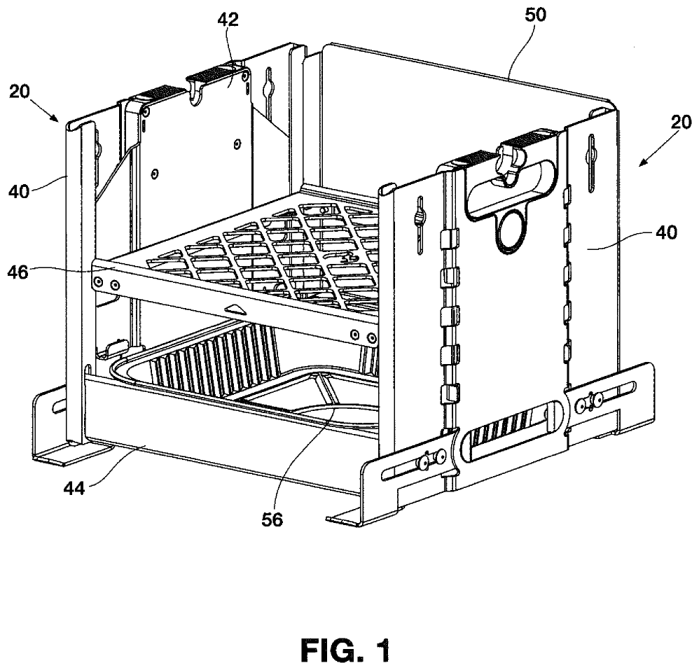

Various parts and accessories described in the foregoing disclosure are described relative to their orientation, position and/or installation with respect to the assembled portable BBQ grill depicted in FIG. 1. For example, various parts and accessories are described herein as having surfaces that face inwards, outwards, upwards, and/or downwards, for which directions and/or orientations are taken in the context as to whether they face towards the inside or outside of the portable BBQ grill assembly, or whether they face upwards or downwards relative to what is understood to be the upright position of the portable BBQ grill assembly shown in FIG. 1.

The portable BBQ grill assembly (or referred to simply as the grill) disclosed herein is a small but versatile grilling system that can be quickly assembled to cook food safely and efficiently over a combustible fuel heat source and then, once cooled, easily dissembled for compact storage. While the compact design and modularity of the grill minimizes its size, particularly when disassembled, which lends to its portability, the assembled grill and the additional features not only simplify cooking, but enhance a user's cooking experience by providing a variety of cooking methods (such as straight grilling, basket grilling, rotisserie) in one versatile and convenient system.

The portable BBQ grill assembly includes two sidewall assemblies and a rear wall that, together, form a three-sided enclosure around a heat source that will cook food overtop. The two sidewall assemblies and the rear wall are secured together at the bottom end of the grill by two cross braces. In the case of a solid fuel heat source, of which may include charcoal, charcoal briquettes, wood, pellets, or some other solid fuel suitable for cooking food, the solid fuel may be placed in a combustion tray at the bottom of the grill assembly which is supported by the two cross braces, the sidewall assemblies, or both. In the case of a gas heat source, a burner assembly can be inserted through one of the sidewall assemblies, with the gas source located external of the grill.

The food to be cooked over the heat source can be supported by a variety of different means including a wire grill (like on a conventional BBQ), a grilling surface, in a cooking basket, or on a rotisserie (or spit). Providing a variety of cooking methods increases the variety of the type of foods that can be cooked, and can simplify cooking and meal preparation. An example of this would be cooking a whole chicken on the rotisserie as opposed to having to prepare and cook all the different components of a whole chicken, or cooking a whole fish or other delicate foods in the grill basket so the food is less likely to fall apart and into the heat source.

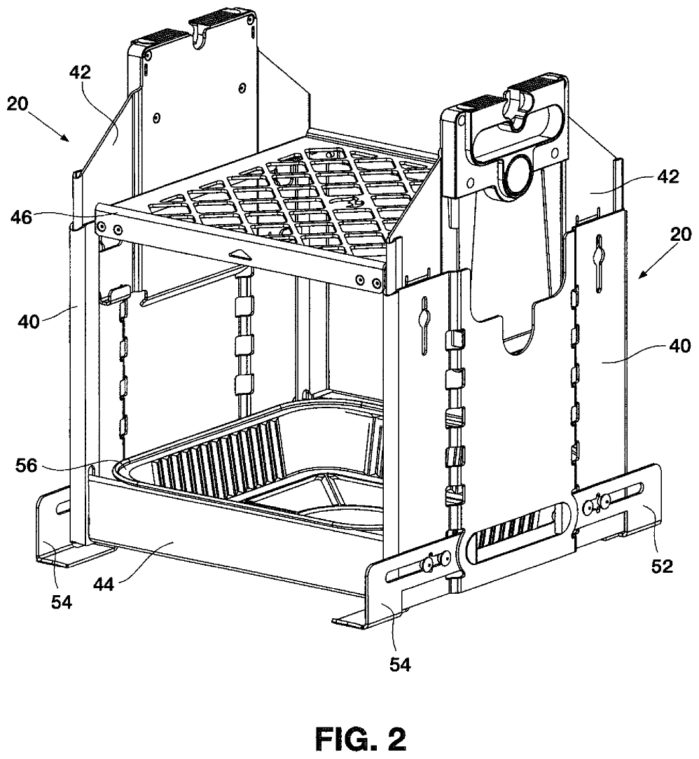

FIG. 1 illustrates the basic portable BQQ grill assembly which includes two opposed sidewall assemblies 20, two opposed cross braces 44 (only one visible), a grilling surface or plate 46, and a rear wall 50. FIG. 2 illustrates the portable BBQ grill shown in FIG. 1, but with each sidewall assembly 20 in a raised position, as compared to FIG. 1 which illustrates the portable BBQ grill with the side wall assemblies in a lowered position. As can be seen in FIG. 2, each of the BBQ grill sidewall assemblies 20 comprise an outer or lower side panel 40 and an inner or upper side panel 42 that is nested therewithin. The height-adjustable upper side panel 42 provide more control over the cooking temperature directed at the food on the grill as their height can be adjusted according to the doneness of the food and/or the intensity of heat.

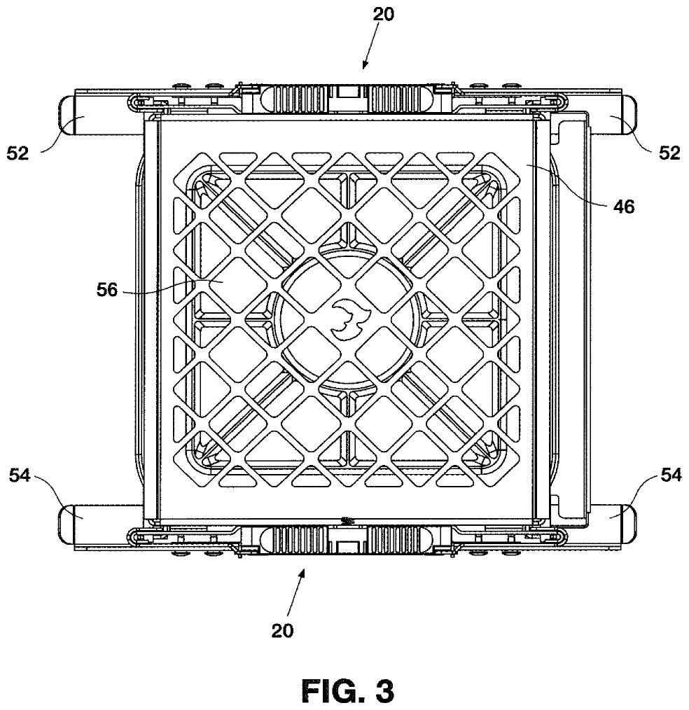

FIG. 3 illustrates the portable BBQ grill from the top. FIGS. 1 to 3 also illustrate right feet 52 and left feet 54 in an extended position. It should be noted that the right feet 52 which are mirror images of the left feet 54 and, in this case, the denotation ‘right’ and ‘left’ is relative to a view of the outward facing side of each lower side panel 40 to which the feet are attached (i.e. the lower side panel 40 on the left side of the portable BBQ grill has both right and left feet). FIGS. 1 to 3 also illustrate a tray 56 to hold and contain the solid combustible fuel, which may be wood, charcoal or briquettes, and the tray 56 may be packaged with the grill or carried separately, or in a case for the BBQ grill.

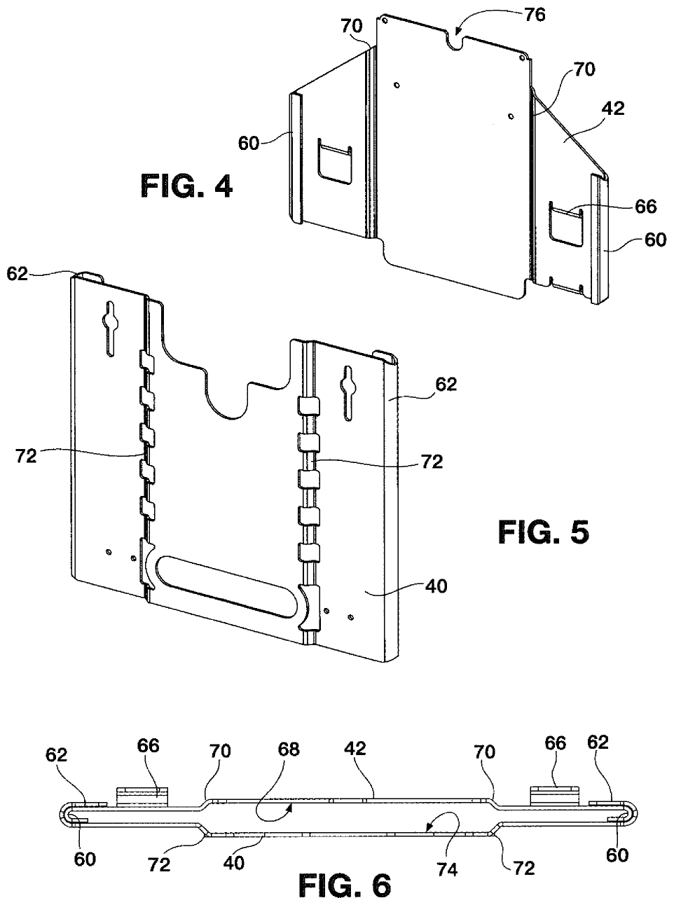

FIGS. 4 and 5 illustrate the upper side panel 42 and the lower side panel 40. FIG. 6 illustrates a top view of the interconnection of the two panels in which the upper side panel 42 is nested within the lower side panel 40. The upper side panel 42 has vertical edges 60 that are outwardly curved and which fit within the vertical edges 62 of the lower side panel 40 that are inwardly curved . The upper side panel 42 also has grilling surface supports 66 that suspend the grilling plate over a heat source. These supports 66 can be C-shaped or L-shaped brackets that extend out from the inside surface of the upper side panel 42 towards the inside of the BBQ grill, and preferably have an upturned lip that engages with the grilling plate to secure it from lateral and transverse movement. The engagement between the grilling surface supports 66 and the grilling plate 46 improves the lateral and transverse stability of the grill assembly.

It will be seen from FIGS. 4 and 6 that the upper side panel 42 has a vertical channel 68 formed therein with a base that is offset inwards, towards the inside of the grill, and that is further defined by two vertical bend sections 70. FIGS. 5 and 6 show a vertical channel 74 formed in the lower side panel 40, but with a base that is offset outwards, opposite the vertical channel 68 formed in the upper side panel 42, and that is further defined by two vertical bend sections 72. The vertical channels 68 and 74 not only increase the rigidity of each side panel to improve the overall stability of the BBQ grill assembly, the enlarged space formed between the two opposing channels 68 and 74, as seen in FIG. 6, acts to guide and support the height adjustment mechanism when raising and lowering the portable BBQ grill. The upper section of the upper side panel 42 has a semi-circular notch 76 to accommodate additional features of the grill assembly to be noted herein.

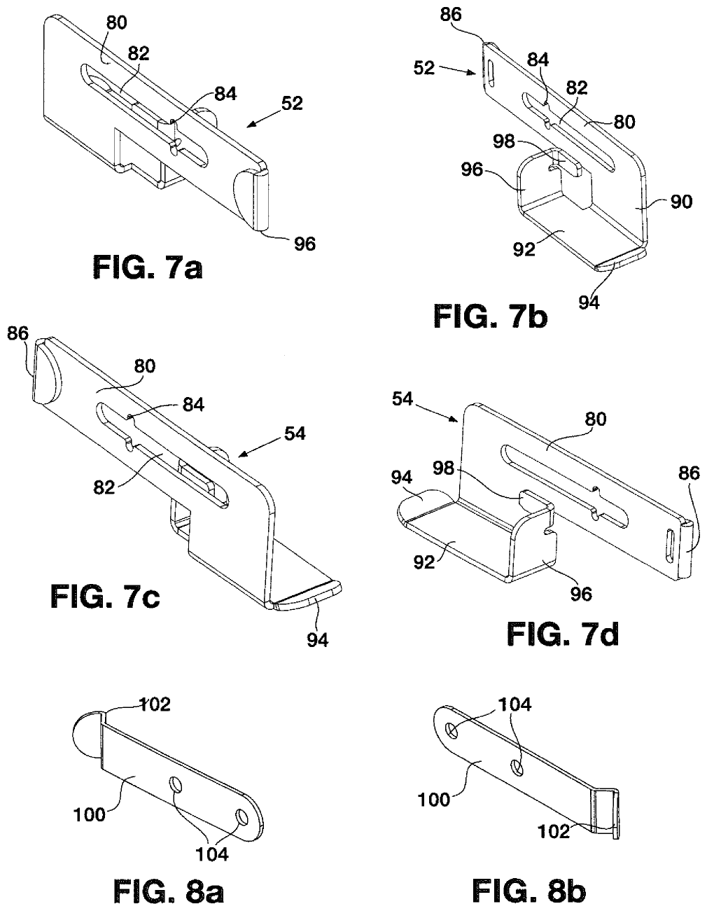

As noted above, FIGS. 1 to 3 illustrate the outer panel 40 with feet 52 and 54, which feet can be extended and retracted. The right foot 52 of each lower side panel 40 is shown in FIGS. 7a and 7b, and the left foot 54, which is illustrated in FIGS. 7c and 7d, is a mirror image of right foot 52. Each of the feet 52, 54 has a horizontally extending leg 80 with a longitudinal aperture 82 with opposed notches 84. The end 86 of the leg 80 has a semi-circular portion bent back on itself to form a guide 88. At the other end of the leg 80 is a vertical section 90 with foot base 92 extending horizontally therefrom. The foot base 92 has an outer end 94 that is slightly raised such that the foot resembles a skid which can facilitate and aid in the extension of the foot surface and in repositioning the assembled BBQ grill on uneven an uneven surface or ground. The foot base 92 has an upturned vertical inner end 96 with a horizontally directed tab 98.

FIGS. 8a and 8b illustrate a flat spring clip 100 with a v-shaped projection 102 and fastening holes 104. At the semi-circular end of the clip is a v-shaped projection 102.

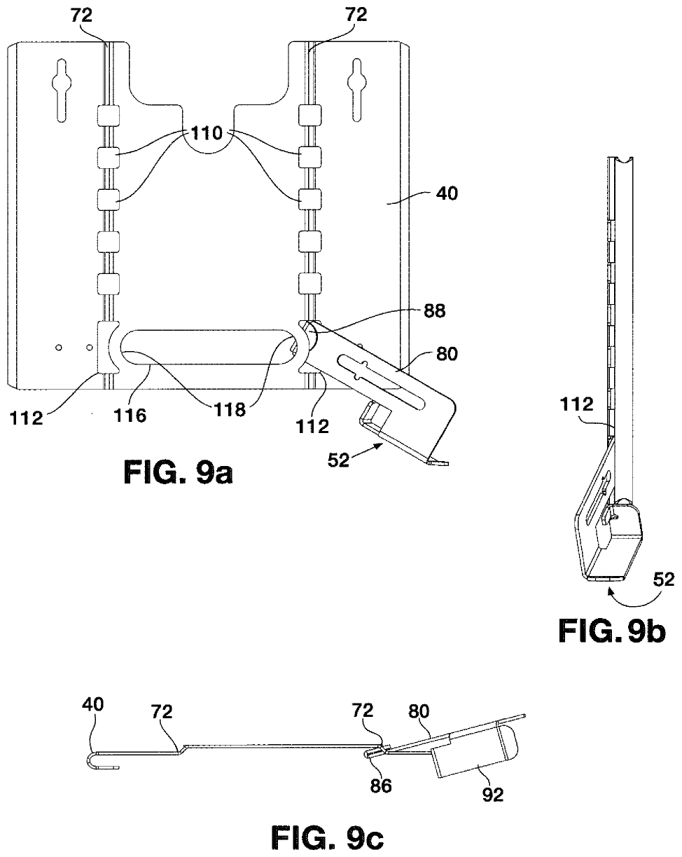

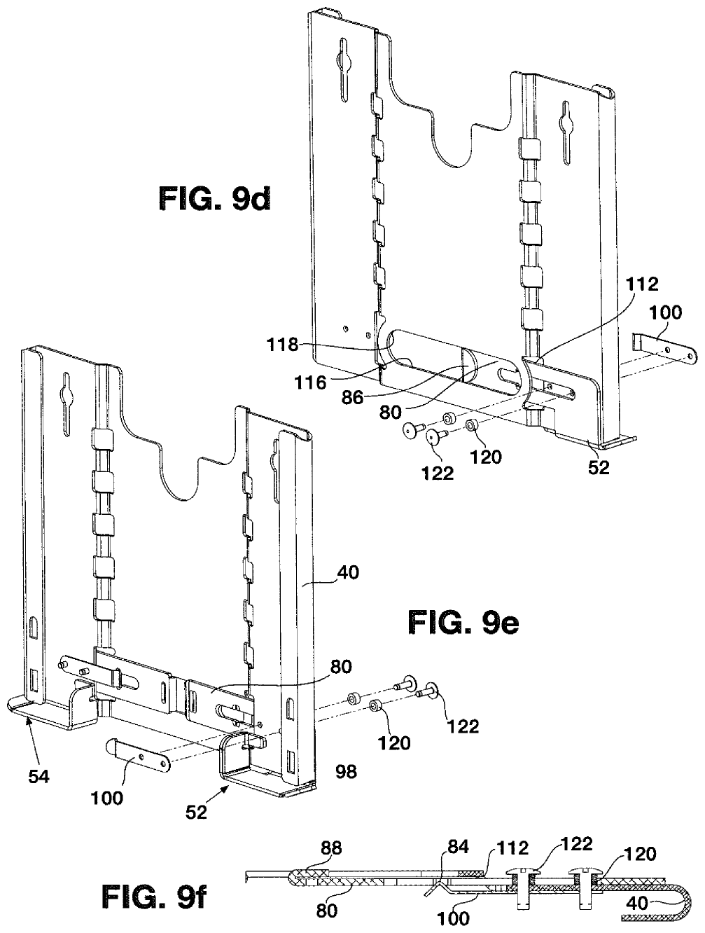

FIG. 9a to FIG. 9e illustrate the connection of foot 52 to the lower side panel 40 facing outwardly. The outer panel 40 has two bends 72 defining the edges of the channel 74. Vertically aligned along each one of the bends 72 are spaced channel latch locks 110, which are apertures in which the pawls 154 (FIG. 11) at the ends of each latch plate leg 152 can engage. In the lower side panel 40, there are also larger lower apertures, or sockets, for the feet to engage with, referred to herein as foot sockets 112. The foot sockets 112 are associated with the sliding extension and retraction of feet 52, 54. Between the left and right foot sockets 112 is the foot guide 116 which is an elongated aperture with curved ends 118.

The flat spring clip 100 is secured at one end to the inside surface of the lower side panel 42 by suitable fastening means 120, 122. The other end of the flat spring clip with the v-shaped projection 102 extends horizontally into the channel section of the lower side panel 42, with the projection 102 in vertical alignment with notches 84 of the foot apertures 82 when the legs are extended. FIGS. 9d and 9e illustrate the fastening of the feet 52, 54, and the assembly of the flat spring clip 100, including spacers 120 and rivets 122. The v-shaped projection 102 of the flat spring clip 100 engages with the notches 84 in the leg 80 of each foot 52, 54 to assist in retaining and securing each foot in an extended position. The flat spring clip 100 and the notches 84 in the leg 80 of each foot 52, 54 are configured such that the spring force of the spring clip 100 may be overcome by simply pushing inwards, on the end of each foot 52, 54, to release the foot from the extended position. Otherwise, the flat spring clip 100 can either be pushed from the outside of the foot, through the foot guide 116 of the outer side panel 40, or disengaged from the inside of the outer side panel 40 by pulling back on the rounded end of the v-shaped projection 102 to release the foot so it slides freely within the apertures of the outer side panel, back to a retracted position.

FIG. 9f is a sectional view taken effectively along line 9f-9f of FIG. 9e of the longitudinal portion of the left foot 52 fastened to left side of the outer panel 40. The sectional view includes the spring clip, spacers and rivets, even though they are shown spaced from the lower side panels in FIG. 9e.

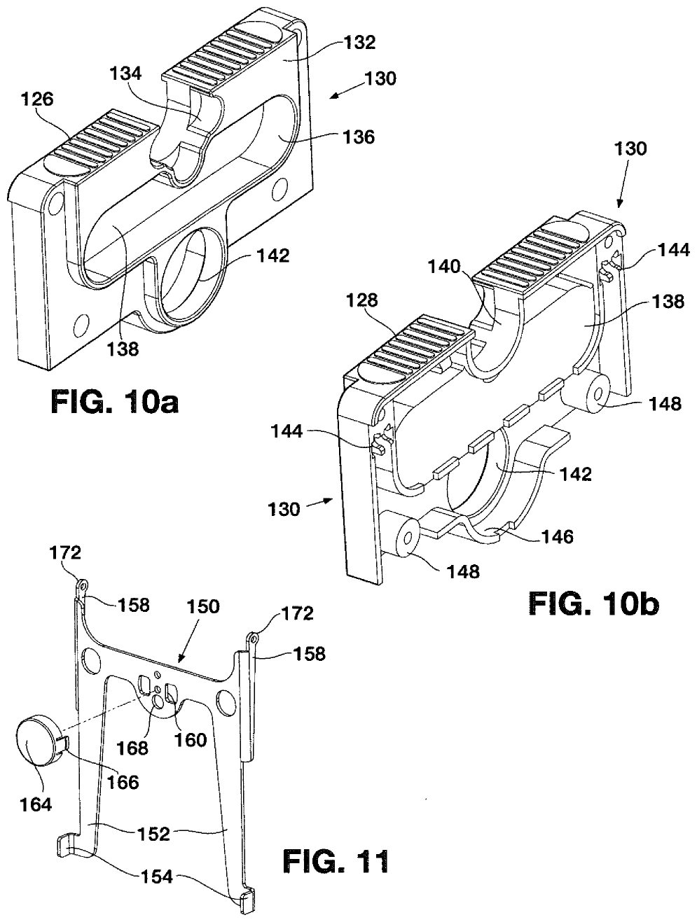

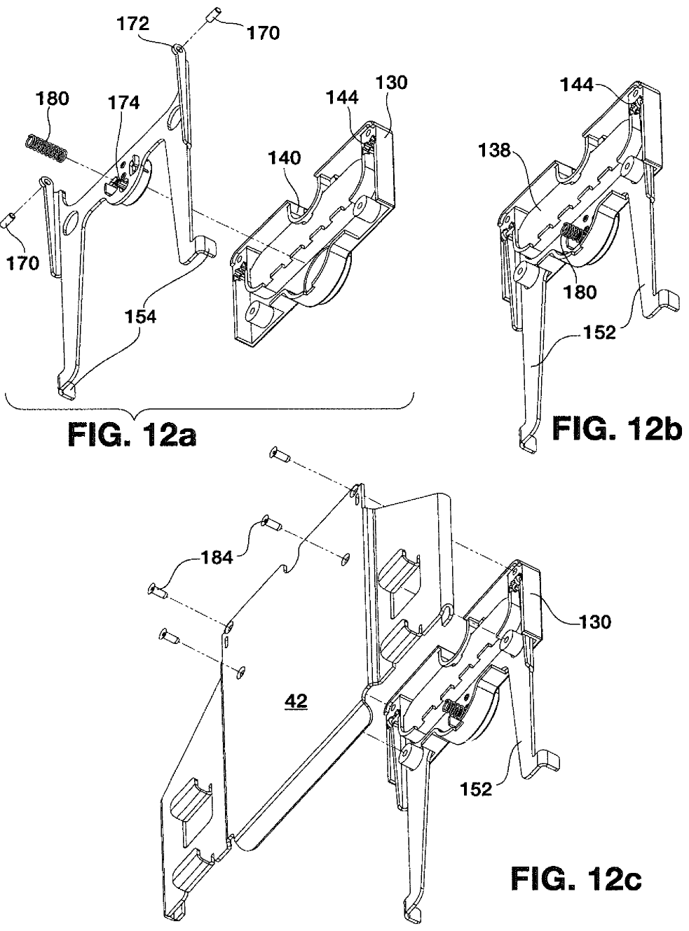

FIGS. 10a, 10b, illustrate respectively, the outer side 126 and inner side 128 of the handle 130. The outer side 126 has a three scalloped section 134 and finger recess 136 with well 138. The inner side 128 has a semicircular section 140 and button aperture 142. The inner side 128 of handle 130 shows a pair of upper spaced-apart pin supports 144 on each side. Also shown is a button shield 146, as well as bosses 148 to support fasteners 184 that secure the handle in attachment to the upper side panel 42 (FIG. 12c).

FIG. 11 shows latch plate 150 having latch plate legs 152, which are a mirror image of each other, with each leg having a projection or pawl 154 at the end, configured and adapted to engage the channel latch locks 110 which are the apertures along the bend sections 72 of the lower side panel 40. The latch plate 150 also has pivot arms 158, as well as button clip apertures 160. Button 164 has radially spaced clips 166 that attach to the latch plate 150 in button clip aperture 160. Other apertures on the latch plate 150 include a spring guide aperture 168.

FIGS. 12a and 12b illustrate the attachment of the latch plate 150 to the handle 130, whereby the pivot pins 170 are inserted into the pivot arm eyelets 172, and then inserted into the pivot pin supports 144 of the handle 130. The spring guide 174 of the button 164 protrudes through spring guide aperture 168 and extends through the spring guide aperture 168, on to which is placed a spring 180. FIG. 12c illustrates the connection of the upper panel 42 to the embodiment of FIGS. 12b with rivets 184.

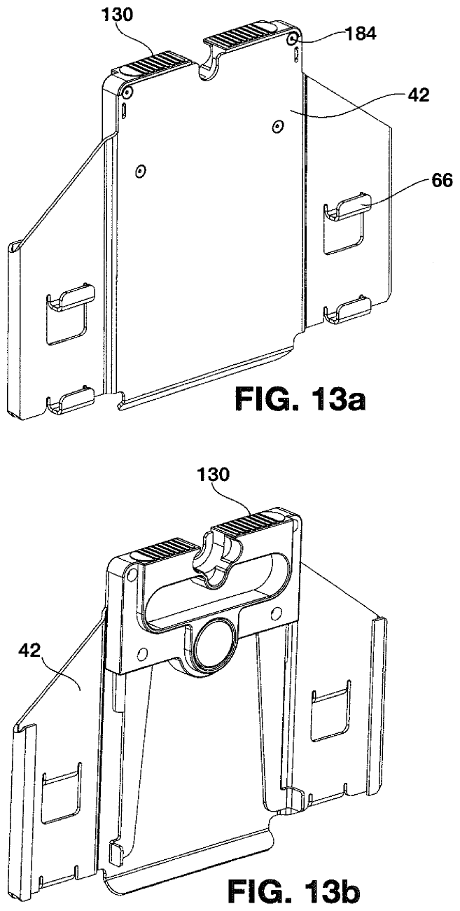

FIGS. 13a and 13b illustrate the completed upper panel assembly with the handles and latch plate, with views respectively from the inside and outside of the panel.

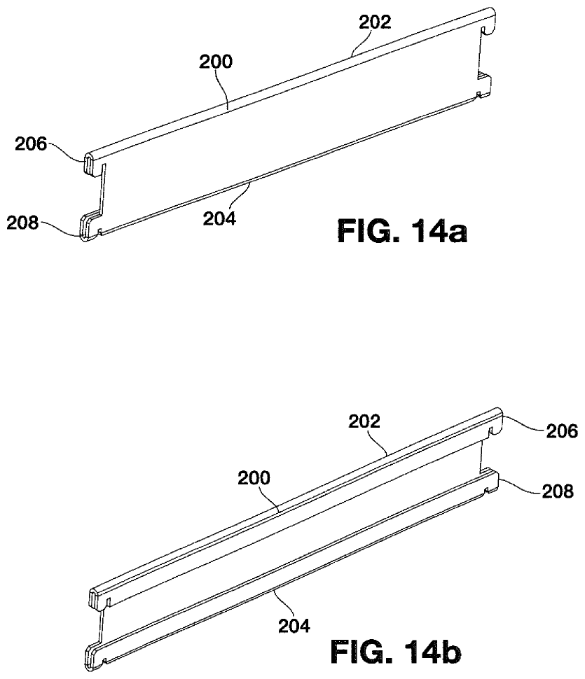

FIGS. 14a and 14b illustrate the cross brace 200 with the long edges folded over to form upper and lower longitudinal rails 202, 204. At the ends of each rail 202, 204, are upper and lower rail hooks 206, 208.

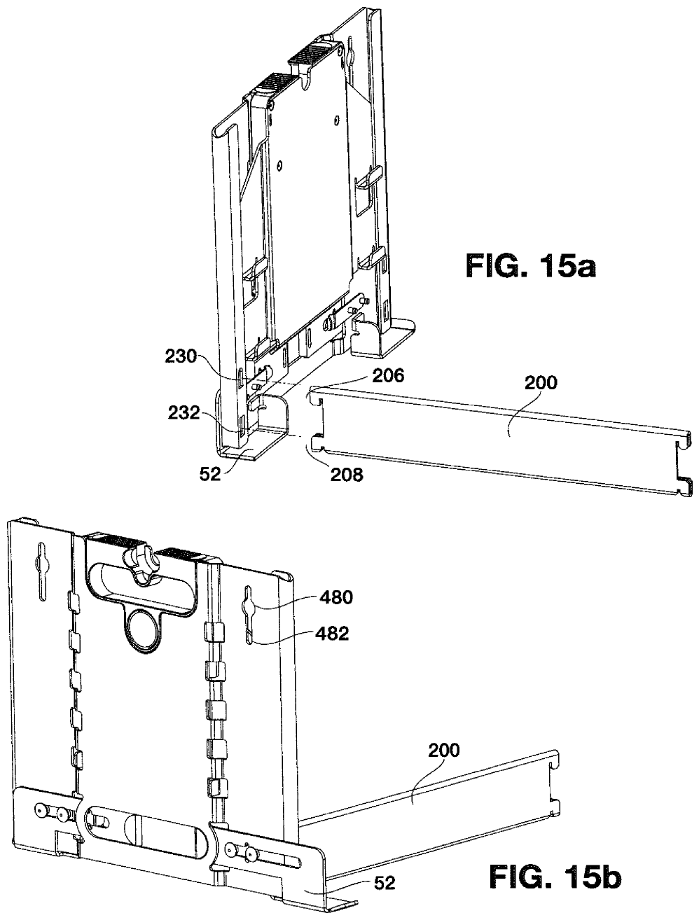

FIGS. 15a and 15b illustrate the attachment of the cross brace 200 to lower panel 40, the rail hooks 206 and 208 inserted into respective rail lock slots 230, 232 in flanges 62 of lower panel 40 and forced downwardly.

As shown in FIG. 15b, foot 52 is extended. The other cross brace 200 is similarly attached to the other side of upper panel 40 and a rear wall 210 slides into place on this cross brace.

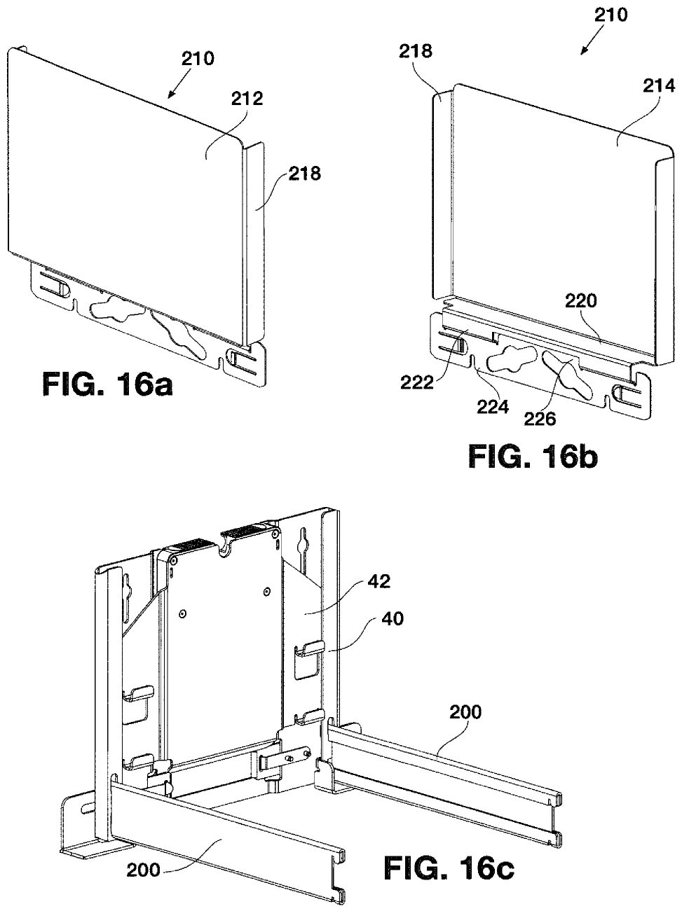

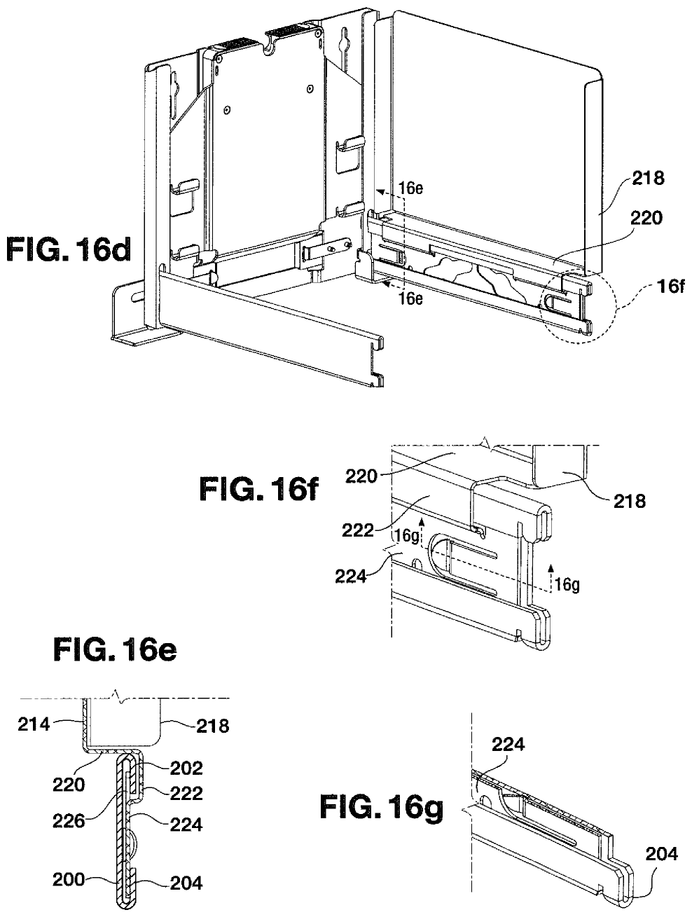

FIG. 16a and FIG. 16b illustrate the rear wall 210, with FIG. 16a illustrating the outer back face 212 and FIG. 16b, the inside face 214 of the rear wall 210. Rear wall has sidewalls 218. A longitudinal ledge 220 extends forwardly from the lower end of the rear wall 210 and is shaped as shown in FIG. 16b to FIG. 16f. An upper vertical part 222 curls into lower vertical part 224 as seen in FIG. 16e. Upwardly directed flange portion 226 extends upwardly from part 224. The spacing between the flange portions of the cross brace flanges 202, 204 is essentially equal to the thickness of the material of the rear wall upper and lower parts 222 and 224. The second lower panel 40 is connected to the free ends of brace 200. FIG. 16e is a sectional view showing rear wall 210 connected with cross brace 200.

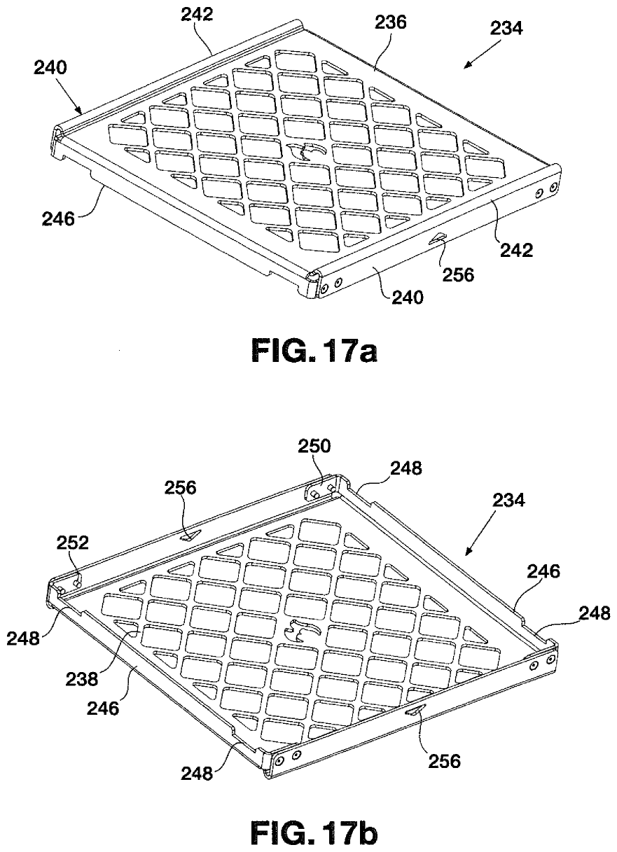

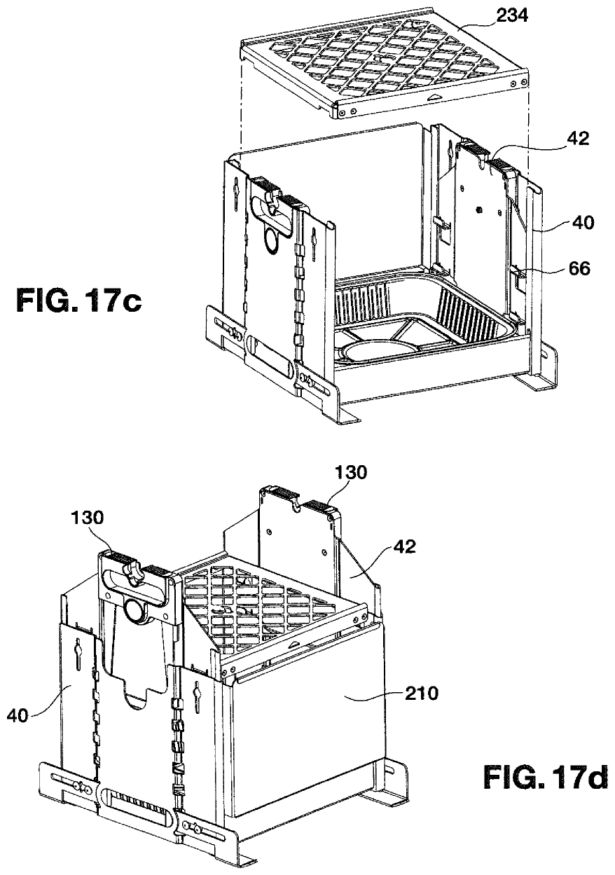

FIGS. 17a and 17b illustrate the grilling plate 234 with upper surface 236 and lower surface 238. Sides 240 have a ridge 242 and end surfaces 246 have indents 248 which are configured to cooperate with the grilling plate supports 66 of the upper panel 42. The sides 240, 246 secured at corners with flanges 250 and rivets 252 as seen in FIGS. 17a and 17b. FIG. 17c illustrates the grilling plate 46 being assembled between the upper side panels 42 which are in a lowered position whereas FIG. 17d illustrates the grilling surface in an upper position. It is also noted that the sides 240 of grilling plate 234 have triangular shaped apertures 256 to connect with a skewer.

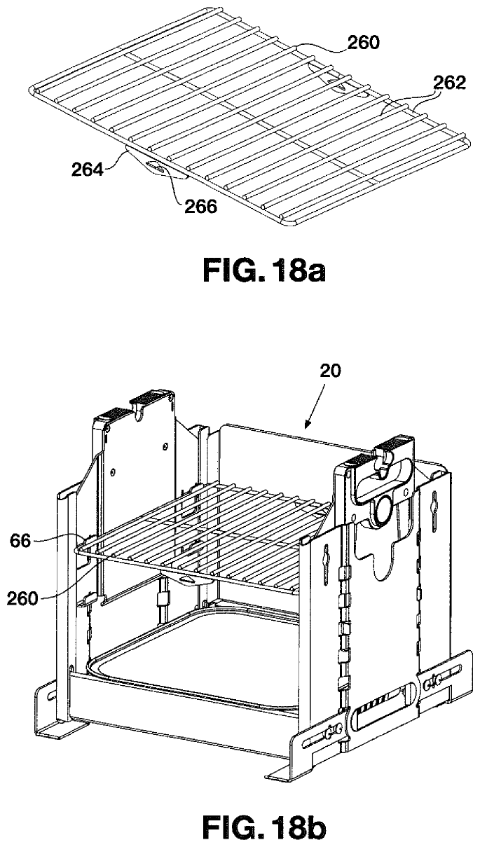

FIGS. 18a and FIGS. 18b illustrate an alternate grill plate 260 of welded metal rods 262 with welded brackets 264 with skewer shaped apertures 266, the grill shown connected with upper side panel hook 66 on a grill assembly 12.

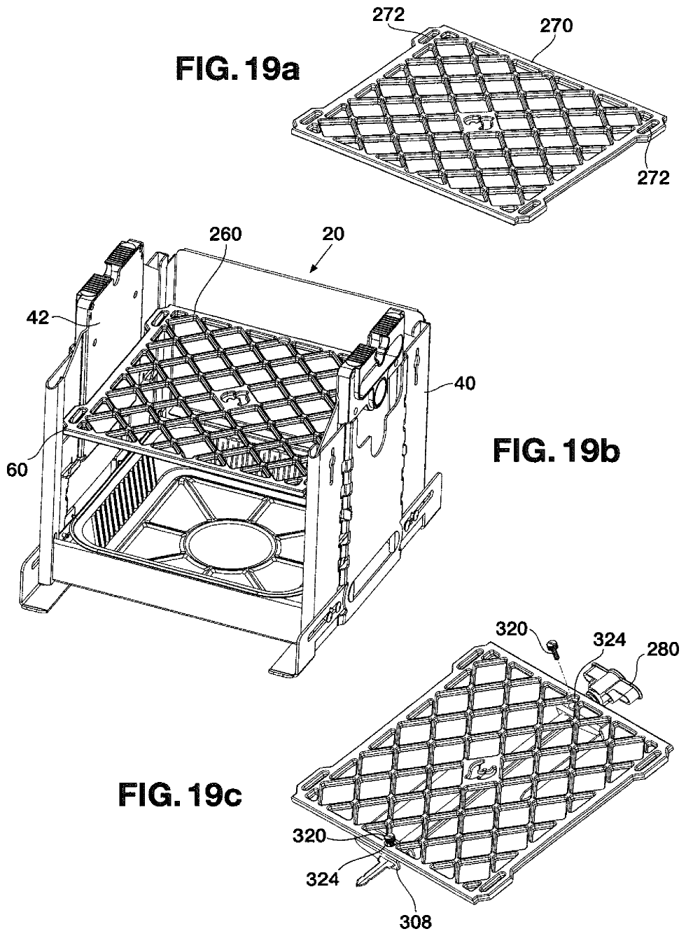

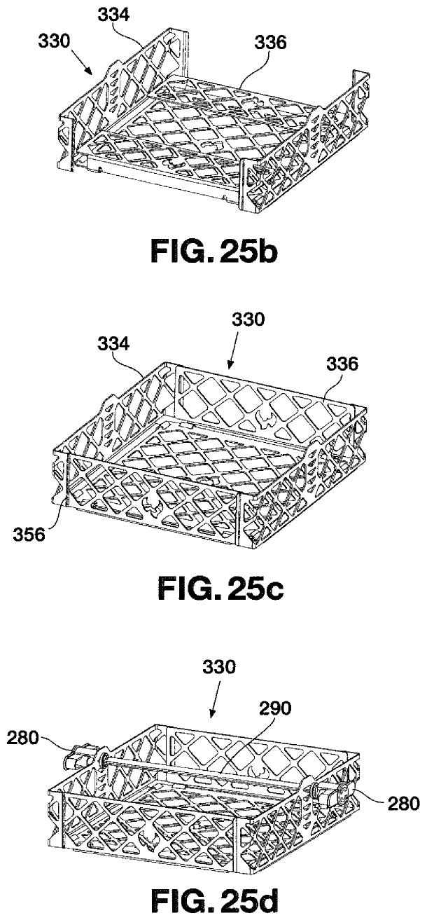

FIGS. 19a and 19c illustrate a further alternate grill plate 270 of cast metal with corner apertures 272 for connection with upper side panel hooks 66 of a grill assembly 20. FIG. 19b illustrates the use of skewer clamps 308 seen in FIG. 19c, to secure the clamp 308 to grill plate 270 with threaded skewer screws 300 passing through holes 324. This grate and skewer would be used with a basket as further illustrated in FIG. 25d herein.

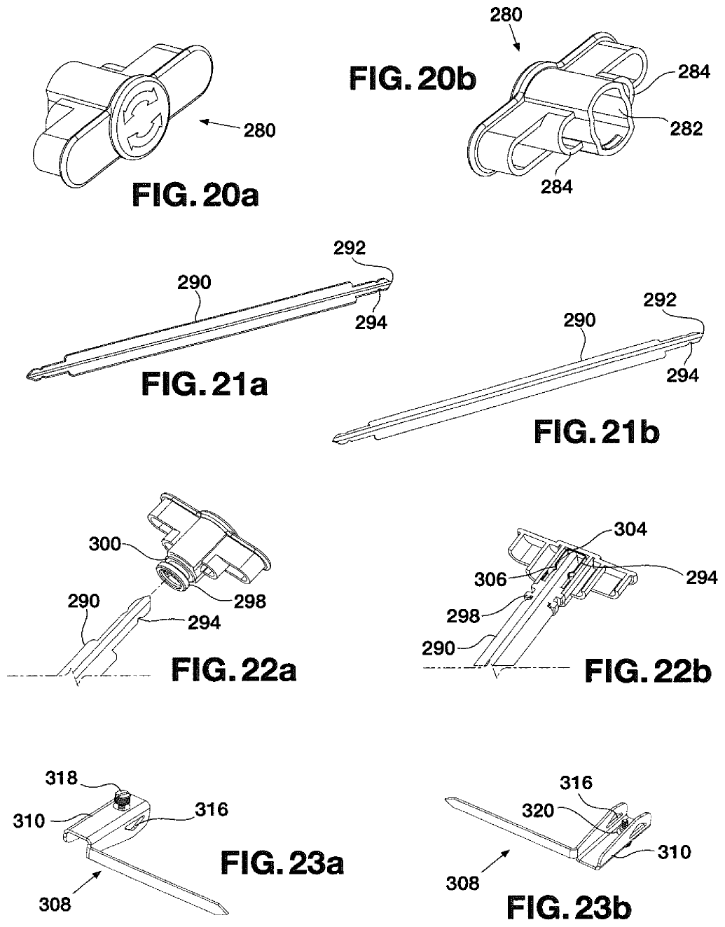

FIGS. 20a and 20b illustrate the outside and inside of a skewer handle 280 with central aperture recess 282 and semi-circular lobes 284.

Skewer 290 is shown in FIGS. 21a and 21b with pointed ends 292 and, the ends having indents 294.

FIGS. 22a and 22b illustrate the detachable connection between the skewer handle 280 and skewer 290. Skewer handle 280 has a cylindrical outer bushing 298 with a cylindrical groove 300, the bushing 298 being secured in handle opening 282. A spring clip 304 with detents 306 is fastened inside handle opening 282, behind bushing 298, and, as seen in FIG. 22b, the detents 306 cooperate with indents 294 of the skewer 290. The handle 280 may be pulled to separate the handle 280 from the skewer.

FIGS. 23a and 23b illustrate a skewer clamp 308 with U-shaped part 310, and perpendicular to part 310 is spike 312. U-shaped part 310 has a triangular skewer opening 316 and threaded screw 318 cooperates with nut 320 fastened to part 310 to secure the clamps 308 to the skewer 290. Although not shown, there is a right skewer clamp, the mirror image of clamp 308. Further, two of the same clamps as shown may be adequate, one placed in an inverted position on a skewer as will be shown further herein.

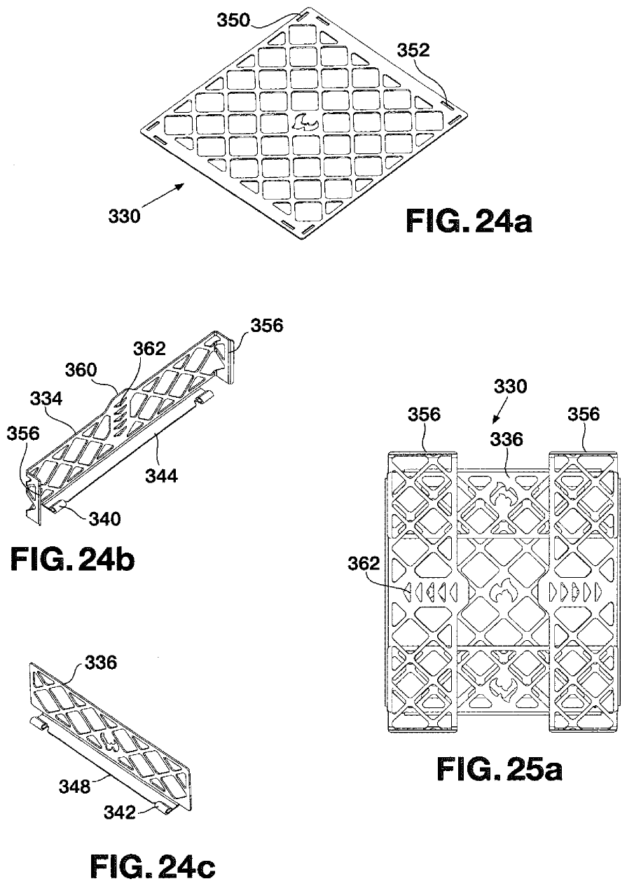

FIGS. 24a to 24c illustrate part of the basket 330 comprising base 332 and sides 334 and 336 (only two shown). Basket sides 334 and 336 have circular clips 340, 342 on flange portions 344 and 348 respectively, which clips are secured to the thin elongate clip openings 350, 352 in the respective sides before the clips are closed. Sides 334 have side flanges 356 and a central portion 360 with a vertical array of skewer shaped slots 362.

FIG. 25a illustrates a top view of the basket 330 in a folded position and FIGS. 25b and 25c illustrate the basket 330 being opened with flange portions 356 containing sides 336. FIG. 25d illustrates the basket with a skewer 290 and skewer with handles 280 connected at the highest basket skewer slots. The basket can be placed on the grill and used for cooking vegetables and potatoes. The lobes 284 of the skewer handle cooperate with the scalloped portion 132 of upper side panel handle 130.

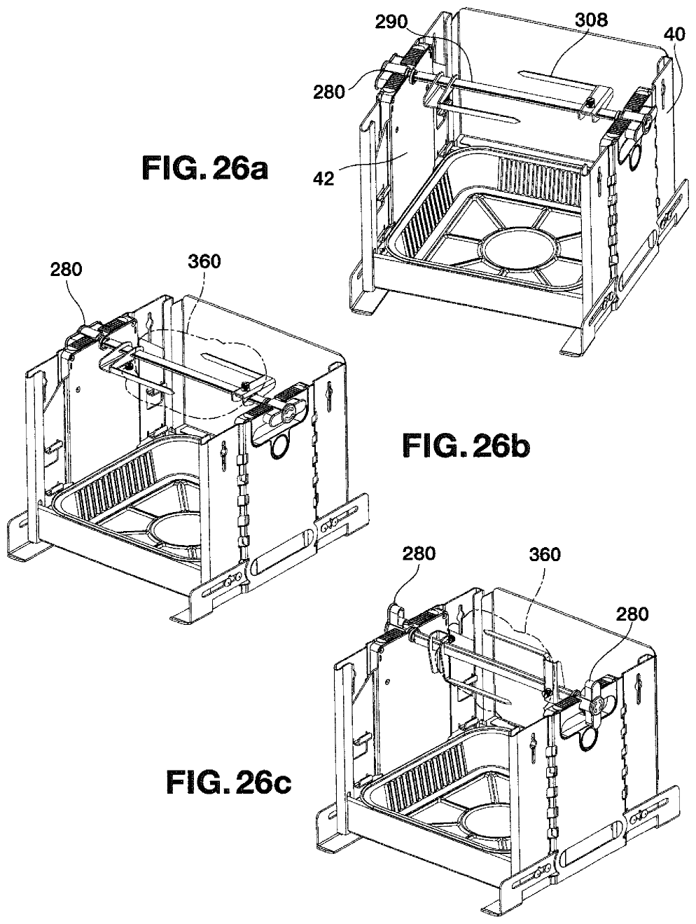

FIGS. 26a, 26b and 26c illustrate the skewer 290 in place with a chicken 370 on the skewer 290. The handles 280 cooperate with the upper curved surface 140 of the upper side panel 42 and the lobes 284 of the skewer handle can be optionally inserted into the scalloped section 134 of the upper side panel to secure the skewer handle at a different orientation at 90° to rotate the chicken 90° or 180°.

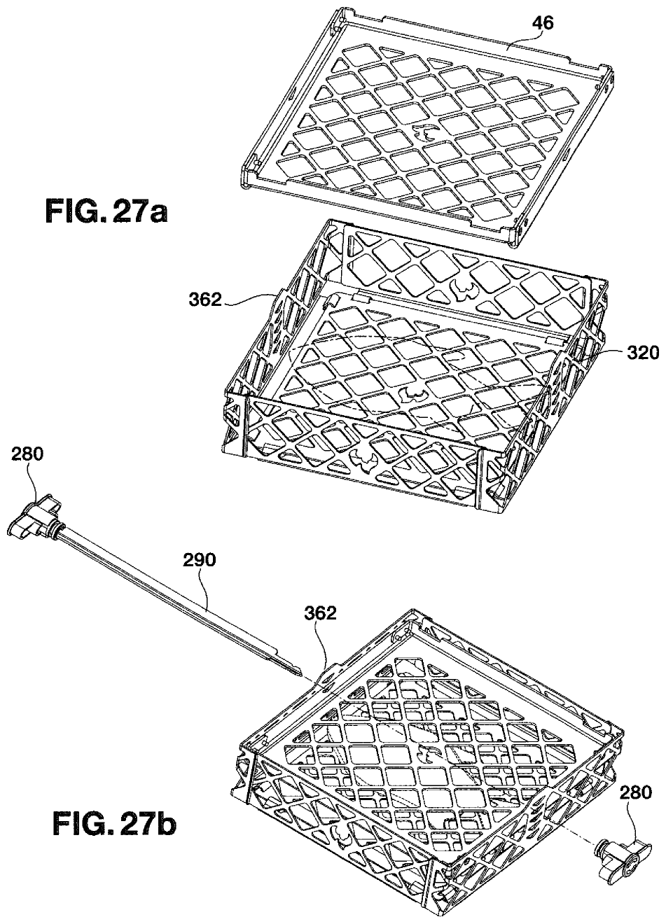

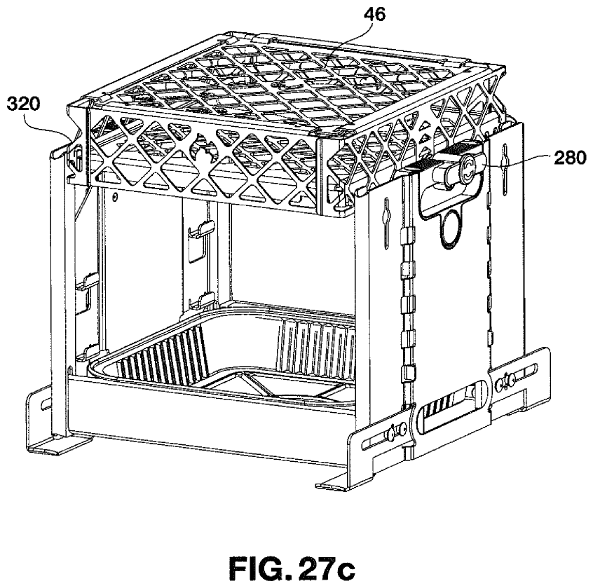

FIGS. 27a, 27b and 27c illustrate the grill plate 46 and basket 320 being assembled to hold food confined, for example, a piece of fish (meat and/or vegetables) which can be manually rotated at 180° intervals with cooperation of the skewer handle lobes 284 and scalloped section 134 of upper side panel handle 130. The assembly is with skewer 290 passed through apertures 362 of the basket and aligned apertures 256 of the grill plate 46, the bottom 234, of the grill plate 46 being up for alignment of the apertures.

### Materials

With respect to the various parts of the BBQ, some materials are considered preferable for enhancing the weight of the parts in a knapsack type of package. The upper side panel handles 130 and skewer handles 280 are of Peek (plastic) materials. The plastics would preferably be shot in their desired colors red and black (versus post-moldpainting) https://dielectricmfg.com/knowledge-base/peek/

The upper and lower side panels and cross braces are preferably Aluminum 5052-H32. This alloy has the formability desired as it does not crack along the bend lines.

The construction of the plastics and metal parts are designed to minimize any conduction paths from the metal. (using air gaps and bosses). Testing thus far has shown that the co-efficient of thermal expansion (CET) differences between the PEEK and the aluminum has not caused problems to date. The design is intended to freely allow the expansion and contractions to occur with minimal effect on either material.

The detents are stainless steel 304 for spring force and corrosion resistance.

The rivets and spacers are preferably aluminum.

### Accessories

When the grill is placed on a table or the like, a protective mat would be advisable, one that is a splatter mat, fire retardant and heat resistant. These mats can be an accessory to the basic grill and are also available on the internet, for example, https://www.amazon.ca/Splatter-Retardant-Resistant-Protective-Outdoor/dp/B07D6MJG4S and https://walmart.ca/en/ip/Camping-Fireproof-Grill-Mat-Cloth-Flame-Retardant-Ember-Mat-Blanket-for-Outdoors-Picnic-Barbecue/PRDAQT1T0ZJ2YQ.

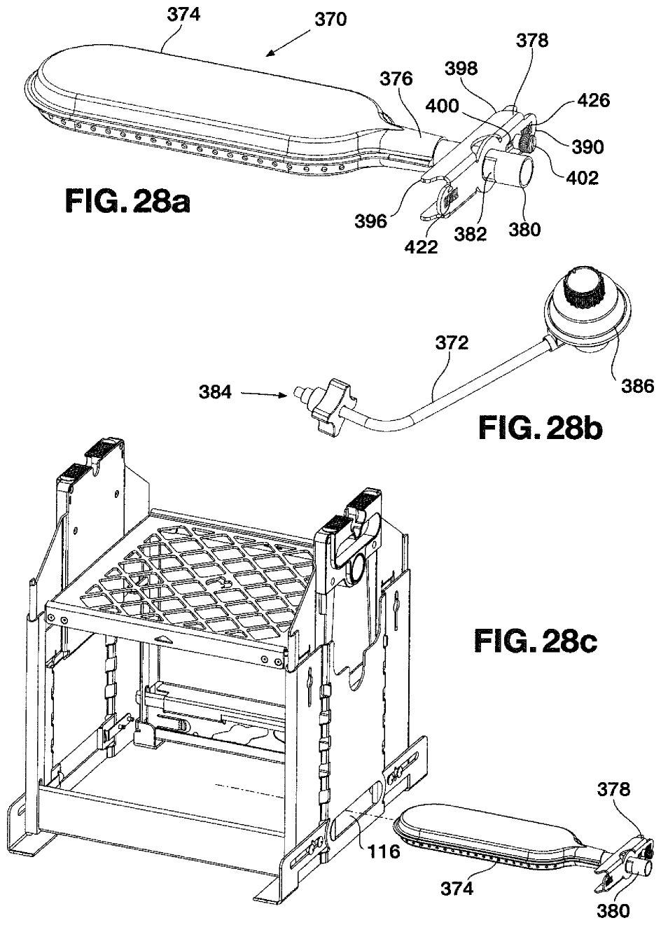

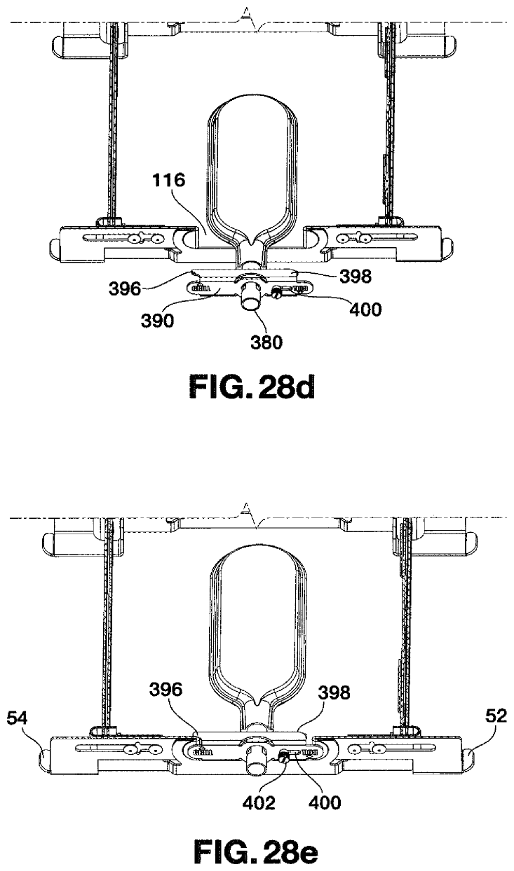

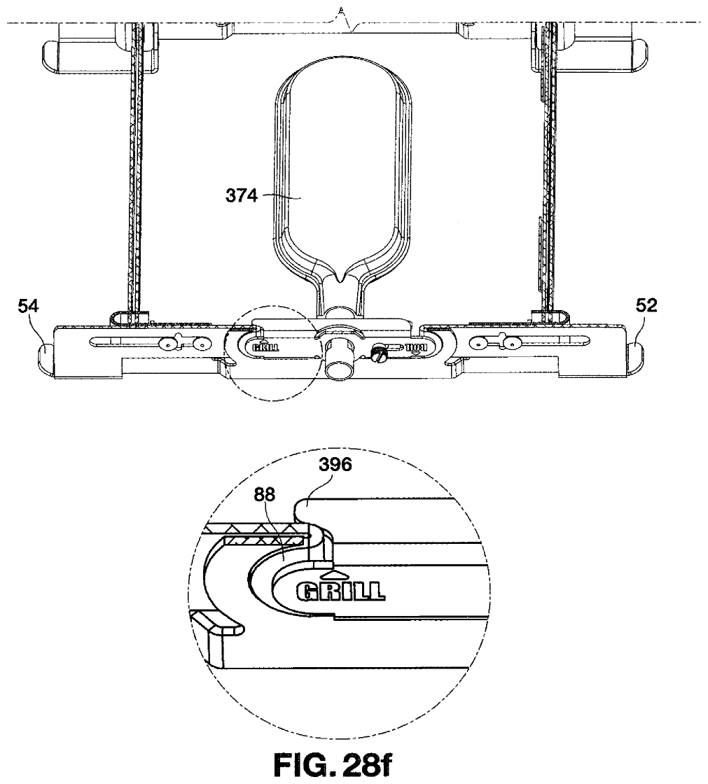

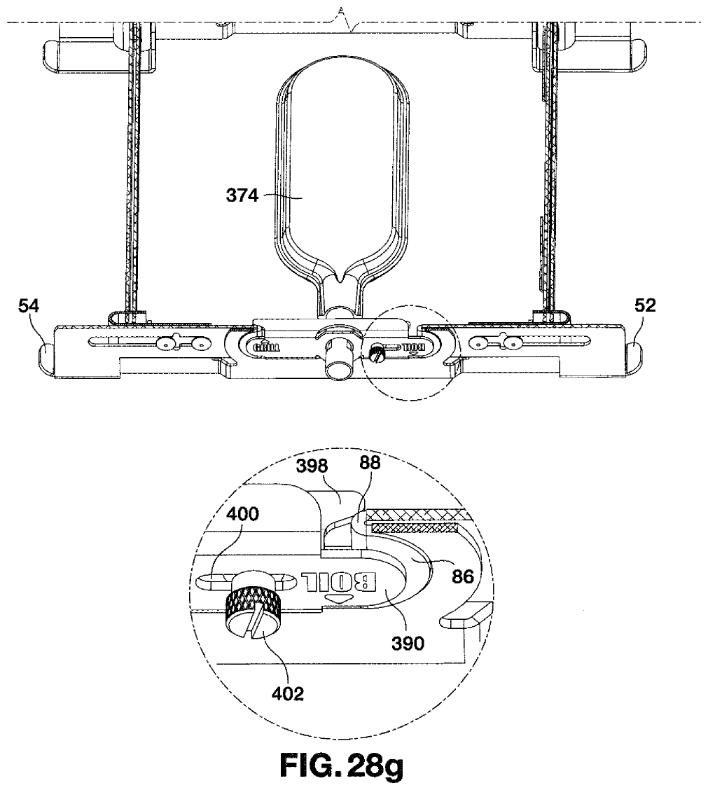

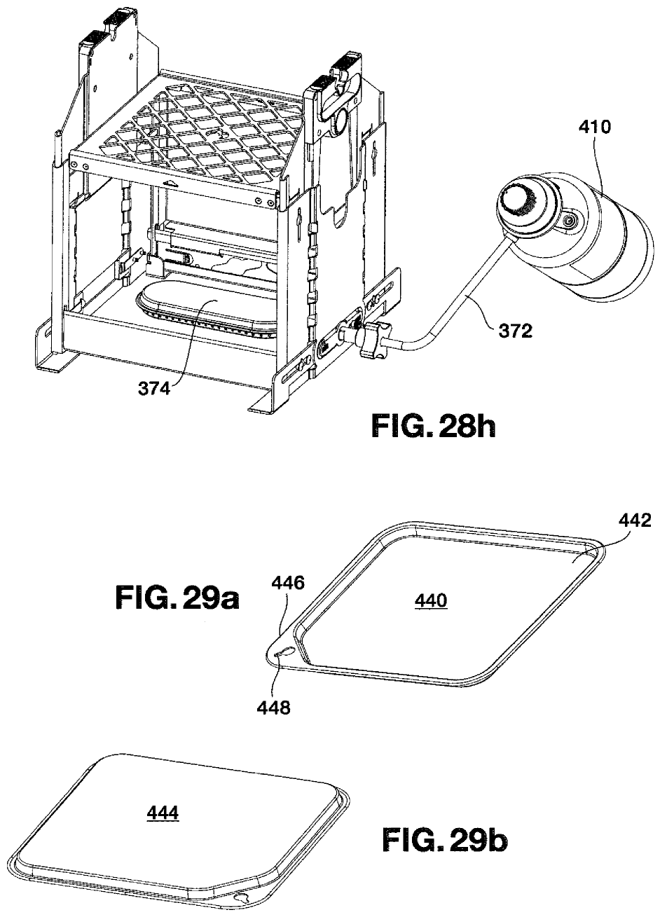

The grill can also be operated with a gas burner assembly and gas feed assembly such as those illustrated in FIGS. 28a-28g. The burner assembly 370 and feed assembly 372 are shown in FIGS. 28a, 28b. The burner assembly comprises burner 374 connected with throat conduit 376 which is connected to a U-shaped clamp 378. Outer conduit 380 has a screen or aperture 382 to allow air to mix with gas in a venturi (not shown). Feed assembly 372 has connection device 384 for connection with conduit 380 and regulator assembly 386 for connection with a gas container. FIGS. 28c to FIG. 28g illustrate the insertion of burner 374 through aperture 116 of lower side panel 40, FIG. 28d to FIG. 28g being views with part of lower side panel 40 removed. U-shaped clamp 378 has front part 390 with a slideable clamp bar 392 connected therewith and within the back of U-shaped clamp 378. Clamp bar 392 has C-shaped clamp part 396 (on the left side) and a curved part 398 (on the right side) (FIG. 28d). The right side of U-shaped clamp 378 has an elongate aperture 400, screw 402 threadably connected to a slide bar 398 (FIGS. 28f and 28g) behind the face of and within the back of clamp 378. FIG. 28d illustrates the clamp bar 392 through lower side panel aperture 116 and FIG. 28e illustrates the clamp bar 398 shifted left so that C-shaped clamp part 396 can be locked behind part of the leg end 86 of left leg 54.

Slide Bar 398 is then slid to the right behind the end 86 of the right leg 53 with screw 402 being rotated to secure the clamp in place as shown in FIG. 28g. When secured, the ends of clamp 378 are respectively in contact with the bent portions 88 of legs 52 and 54. Once the burner assembly 370 is secured in place with the lower side panel 40, the feed assembly 372 and gas container 410 may be connected as shown in FIG. 28h. It will be noted from FIG. 28a that the burner assembly is shown with the holes 420 on the lower part of the burner in a “grill” position as noted by the sign 422. It may be preferred in boiling water or the like for the burner 370 to be connected with the holes 420 on the upper part in a “boil” position in which case the connection of the clamp 378 would have the screw 402 of the clamp 378 on the left side and the sign 426 would be up indicating a “boil” orientation for the burner assembly. Enlarged portions associated with FIGS. 28f and 28g are shown in squares on those figures.

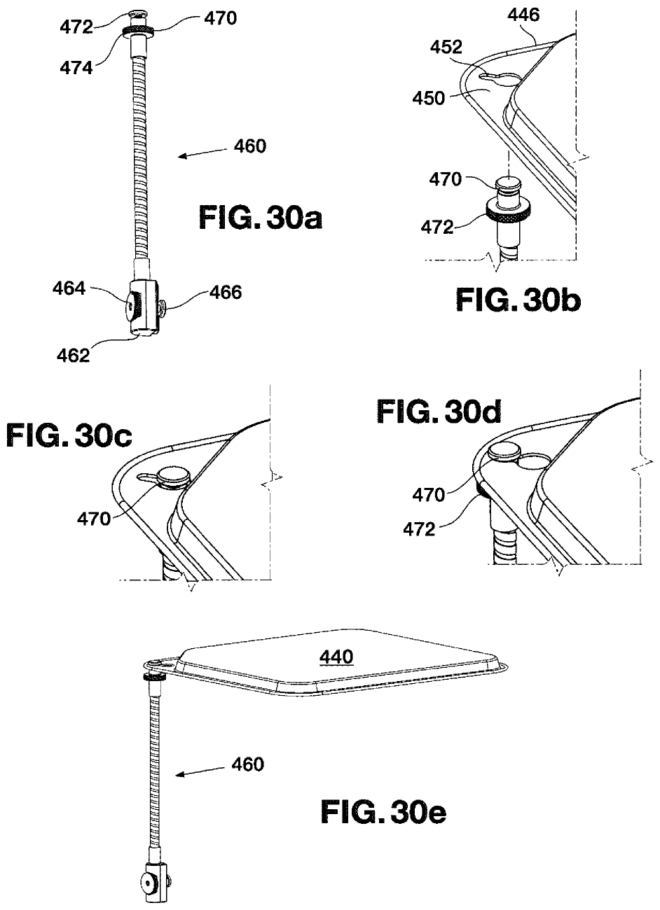

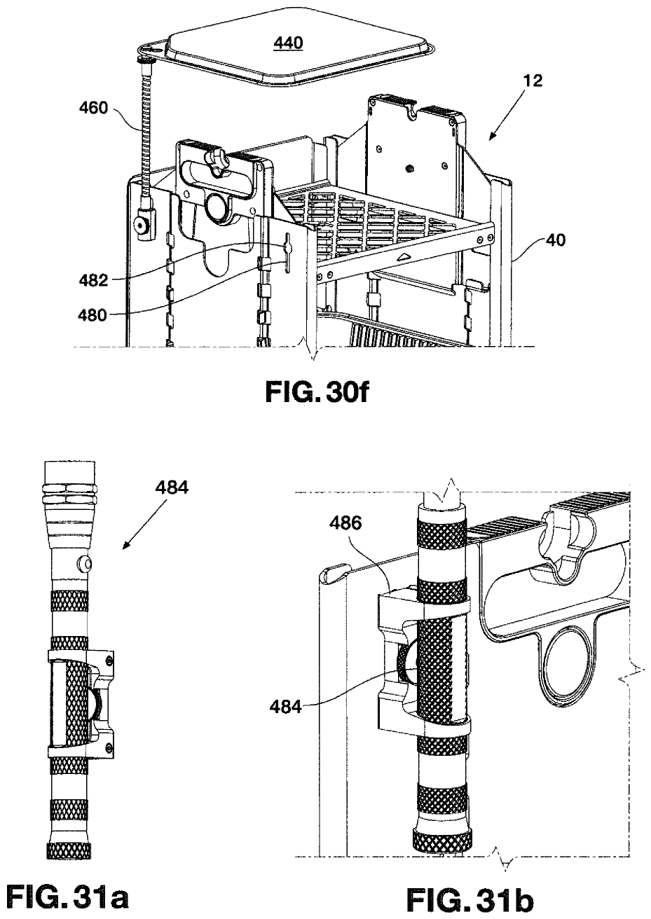

A further accessory is illustrated in FIG. 29a and FIG. 29b and FIGS. 30a to 30c. FIGS. 29a and 29b illustrate a pan 420 with top 442 and bottom 444. One corner of the pan 440 has a flange 446 with an aperture shaped with a circular portion 450 and an elongate slot 452.

FIG. 30a illustrates a rod 460 having a lower end 462 with an outer screw 464 connected to inner catch 466 and an upper end 470 with catch 472 and threaded wheel assembly 474. On the lower side panel 40 are elongate slots 480 with a circular aperture 482. Rod 460 is attached to lower side panel 40 with latch 466 inserted through aperture 482 and slid into elongate slot 480 with threaded wheel assembly 474 rotated to secure the rod 460 to the grill. The pan 440 is connected to the upper rod end 470 with catch 472 and threaded wheel assembly 474. FIGS. 30b, 30c and 30d illustrate the connection of rod 460 and pan 420, similar to that for the rod 460 to lower side panel 40. FIGS. 30e and 30f illustrate the attachment of the rod 460 and pan 420 as a weather shield. Pan 440 can also be used as a frying pan.

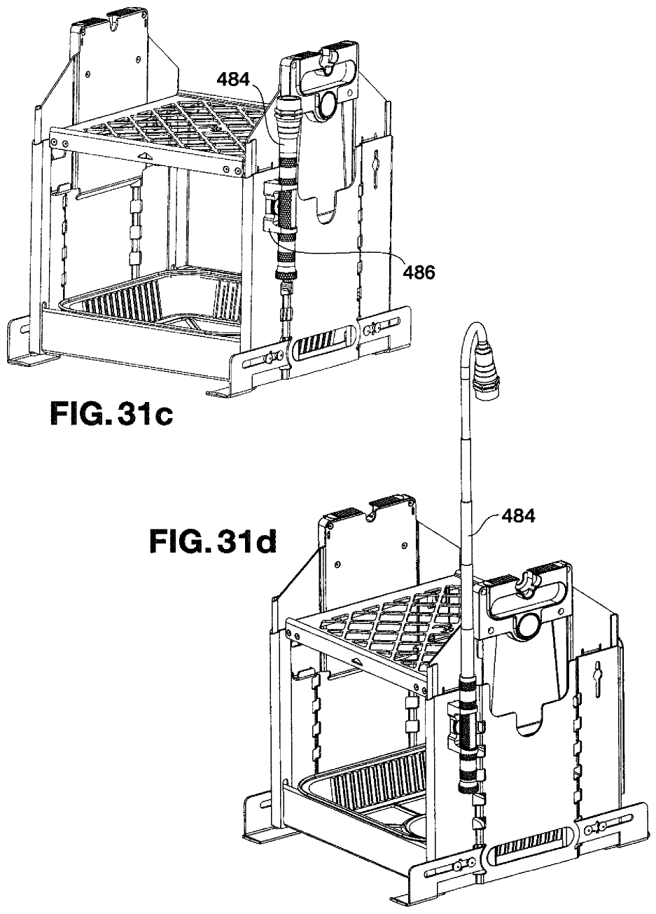

FIGS. 31a, 31b, 31c and 31d illustrate the attachment of telescopic light 484 with light clamp 486 which has a similar connection with lower side panel 40 as illustrated with the shield FIG. 30f.

It is further noted that slots 480 and apertures 482 would also provide means to secure a motor to the lower side panel for providing a rotisserie aspect to the grill with the skewer 290. The motor could be a windup motor or battery operated motor.

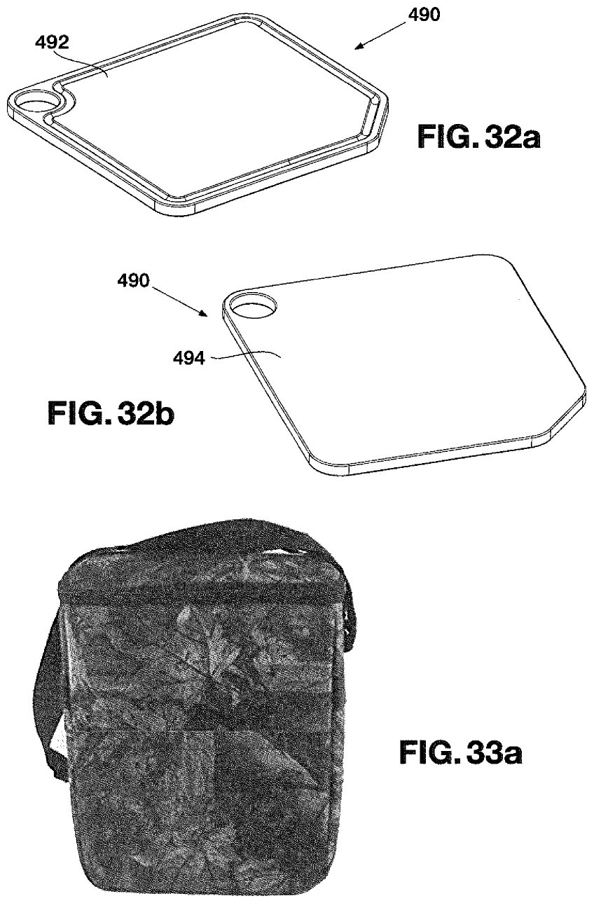

A final accessory is a utility or cutting board 460 illustrated in FIGS. 32a and 32b with the top 462 and bottom 464.

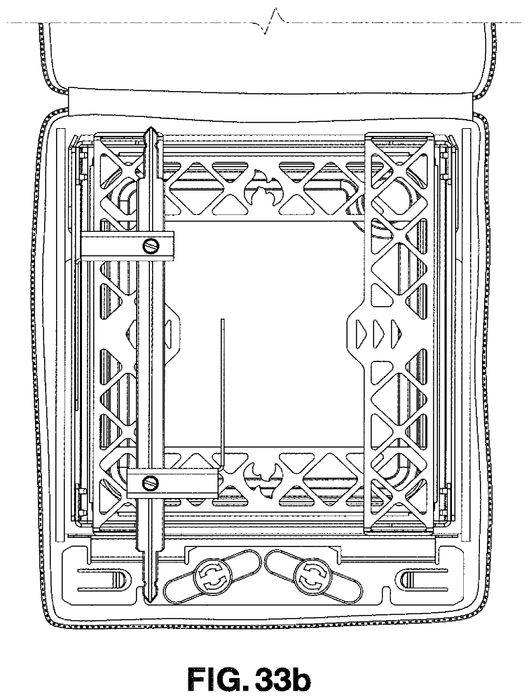

FIGS. 33a and 33b illustrates a carry kit or case and a collapsed grill in the carry case.

1. A portable BBQ grill comprising:
two lower side panels;
two cross braces configured to connect with sides of the lower side panels and space the lower side panels apart;
two slideable upper side panels, each configured to slideably connect with one of the lower side panels; and
a grill plate configured to detachably connect with the slideable upper side panels.

2. The grill according to claim 1 wherein at least one lower side panel has legs adjacent opposed sides of the at least one lower side panel and slideably connected to a lower part of the at least one lower side panel, the legs slideable from an inner retracted position to a laterally outer extended position.

3. The grill according to claim 2 wherein the at least one lower side panel has laterally spaced vertically extending bends inwardly of side edges of the lower side panel and defining a channel therebetween; the channel at the lower end of the at least one lower side panel having a horizontally extending aperture between the vertically extending bends; and laterally outward of each end of said horizontally extending aperture and within a bend is a leg socket configured to permit a part of the adjacent leg to slide within the leg socket.

4. The grill according to claim 3 wherein said part of the leg in the socket has an elongated horizontal slot with vertically opposed indents, the leg further having a foot base perpendicularly connected to the leg part; and said leg being secured to the lower side panel for sliding within the leg socket; and a decent for alignment with the vertically opposed indents in the slot when the leg is extended, the detent connected to the lower side panel.

5. The grill plate according to claim 1 wherein the lower side panel has a plurality of vertically aligned latch apertures in the vertically extending bends.

6. The grill plate according to claim 5 wherein each upper side panel has a handle assembly, the handle assembly comprising a spring activated latch plate with latch pawls adapted to engage latch apertures in the adjacent lower side panel, the handle assembly further comprising a button to selectively release the latch pawls to adjust a height of the upper side panel relative to the adjacent lower side panel.

7. The grill according to claim 6 wherein the handle has a recess above the button configured to accept fingers of a user and further having a skewer handle recess configured to detachably accept a skewer handle.

8. The grill according to claim 1 wherein the cross braces have ends configured to engage slots on sides of the lower side panel, and further comprising a shield configured to detachably connect with one of the cross braces.

9. The grill according to claim 8 wherein he bottom of the shield is configured to slideably connect with the one of the cross braces.

10. The grill according to claim 1 wherein an inside of each said upper side panel has laterally spaced hook elements, the grill plate having opposed end means configured to detachably connect with the hook elements.

11. The grill according to claim 10 wherein the grill plate has sides with a peripheral flange and two opposed side flanges having indents to detachably connect with the hook elements.

12. The grill assembly of claim 10 wherein the grill plate is of cast metal and comprises a peripheral border with spaced apertures configured to connect with the hook elements of the upper side panel.

13. The grill assembly of claim 10 wherein the grill plate comprises welded metal rods wherein opposed end metal rods are adapted to detachably connect with the hook elements of the upper side panels.

14. The grill assembly of claim 1 wherein opposing sides of the grill plate include apertures configured to accept a skewer.

15. The grill according to claim 6 further comprising a skewer having detachable skewer handles, the skewer handles adapted to detachably connect with the handle assemblies of the upper side panels.

16. The grill according to claim 15 wherein the skewer handle has a bushing with a circumferential groove and has an opening to accept an end of the skewer, the skewer handle having a detent clip within the handle for connection with detents adjacent the ends of the skewer.

17. The grill according to claim 16 further including at least one skewer clamp with a tine, the at least one skewer clamp including a clamp skewer aperture and means to secure the clamp to the skewer.

18. The grill according to claim 14 further comprising a collapsible basket having two opposed sides having a plurality of basket skewer apertures adapted to connect with the skewer, the basket adapted to form a food holding container in cooperation with the grill plate and the skewer, the interior of the container sized according to the selection of basket skewer apertures with the grill plate.

19. The grill according to claim 18 wherein the collapsible basket comprises a base and four sides, the sides being hinged to said base, two opposed sides of the basket further having side flanges which support the other sides when the basket is open.

20. The grill according to claim 1 further comprising the lower side panel having at least one aperture to which a support clamp can be detachably connected.

21. The grill according to claim 20 further including a telescopic light standard and the support clamp is configured to support said light standard.

22. The grill according to claim 20 further including a rod and shield, the clamp adapted to detachably support the rod, and the rod having an upper end with means adapted to detachably support the shield over the grill.

23. The grill assembly according to claim 22 wherein the shield can operate as a frying pan on the grill.

24. The grill according to claim 1 further comprising a gas burner assembly, the gas burner assembly comprising a gas burner unit and a gas connector unit, the gas burner unit adapted to pass through the horizontal aperture of the lower side panel when the legs are in an extended position, the burner unit having clamp means for detachably securing the gas burner unit to the lower side panel adjacent an inner end of the extended legs.

25. The grill according to claim 24 wherein the clamp means of the gas burner unit has an elongate U-shaped configuration with one end of the clamp means having a lateral projection and the other end of the clamp means having a laterally moveable projection with a fastening means, wherein the lateral projection is located behind the inner end of one leg and the moveable projection is laterally moveable and located behind the inner end of the other leg with the fastening means securing the clamp in place.

26. The grill according to claim 25 wherein the gas connector unit is connected the gas burner unit with a container of gas connected to the gas connection unit.

27. The grill according to claim 1 wherein the lower side panels, cross braces, legs and grill plate are of aluminum 5052-H-32.

28. The grill according to claim 27 wherein the handle and button of the upper side panels are of PEEK Plastic, the latch plates of steel, and the rest of the upper side panels of aluminum 5052-H32.

29. (canceled)
